(19) United States
(12) Patent Application Publication
(10) Pub. No.: US 2025/0149765 A1
(43) Pub. Date: May 8, 2025

(54) BATTERY AND ELECTRIC DEVICE

(71) Applicant: Dongguan Amperex Technology Limited, Dongguan City (CN)

(72) Inventors: Biao Wu, Dongguan City (CN); Tong Ge, Dongguan City (CN)

(73) Assignee: Dongguan Amperex Technology Limited, Dongguan City (CN)

(21) Appl. No.: 18/934,393

(22) Filed: Nov. 1, 2024

(30) Foreign Application Priority Data
Nov. 2, 2023 (CN) 202311452124.9

(51) Int. Cl. H01M 50/595; H01M 50/533

(52) U.S. Cl. CPC H01M 50/595; H01M 50/533

(57) ABSTRACT

A battery includes a housing, an electrode assembly, a first tab, and a protective member. The electrode assembly is accommodated in the housing, and the electrode assembly includes a first electrode plate, a second electrode plate, and a separator, where the first electrode plate and the second electrode plate have opposite polarities, and the separator is arranged between the first electrode plate and the second electrode plate. The first tab includes a first portion, a second portion, and a third portion, where the second portion connects the first portion and the third portion, the first portion is connected to the first electrode plate, and the third portion extends out of the housing. The protective member is fixed to the separator or the second portion, and the protective member is located between the second portion and the electrode assembly to insulate and isolate the second portion from the second electrode plate.

### CROSS-REFERENCE RELATED APPLICATION

This application claims priority to the Chinese Patent Application Ser. No. 202311452124.9, filed on Nov. 2, 2023, the content of which is incorporated herein by reference in its entirety.

### TECHNICAL FIELD

This application relates to the field of battery technologies, and specifically to a battery and an electric device.

### BACKGROUND

Batteries have been widely used in fields such as portable electronic devices, electric transportation tools, electric tools, unmanned aerial vehicles, and energy storage devices. As application environments and conditions become increasingly complex, higher requirements are imposed on safety performance of batteries.

### SUMMARY

Embodiments of this application provide a battery and an electric device so as to improve safety performance of batteries.

According to a first aspect, an embodiment of this application provides a battery. The battery includes a housing, an electrode assembly, a first tab, and a protective member. The electrode assembly is accommodated in the housing, and the electrode assembly includes a first electrode plate, a second electrode plate, and a separator, where the first electrode plate and the second electrode plate have opposite polarities, and the separator is arranged between the first electrode plate and the second electrode plate. The first tab includes a first portion, a second portion, and a third portion, where the second portion connects the first portion and the third portion, the first portion is connected to the first electrode plate, and the third portion extends out of the housing. The protective member is fixed to the separator or the second portion, and the protective member is located between the second portion and the electrode assembly to insulate and isolate the second portion from the second electrode plate.

In the foregoing technical solution, the protective member is arranged between the second portion of the first tab and the electrode assembly, which effectively reduces the risk of short circuit caused by the contact between the second portion of the first tab and the second electrode plate, greatly reduces the risk of fire and explosion of the battery, and improves the safety performance of the battery. In a case that a short circuit occurs in the battery, an internal gas pressure of the battery is relatively high, the battery swells severely, the first tab is pulled and likely to be deformed. The protective member is ranged between the second portion of the first tab and the electrode assembly, so that the protective member can reduce the risk of the first tab being pulled and deformed due to swelling of the battery and being in contact with the second electrode plate, thereby lowering the risk of secondary short circuit of the battery, further reducing the risk of fire and explosion of the battery, and improving the safety performance of the battery. The protective member is fixed to the separator or the second portion, which can enhance the installation stability of the protective member. Even after the internal environment of the battery changes, the protective member can maintain a stable relative position, thereby effectively insulating and separating the second portion of the first tab from the second electrode plate, which helps to improve the safety performance of the battery.

In some embodiments of the first aspect of this application, an adhesive force between the protective member and the separator is F, where 6 N/m≤F≤50 N/m. If the adhesive force is too small, the protective member and the separator are not stably fixed and are easily dislocated and detached during falling. Theoretically, the adhesive force between the protective member and the separator should be greater. However, due to material and process limitations, the adhesive force of the protective member is generally not greater than 50 N/m.

In the foregoing technical solution, the protective member is bonded to the separator, with simple connection method and good connection stability. 6 N/m≤F≤50 N/m, so that the protective member and the separator have good connection stability, and the battery has good infiltration performance, and thus the battery has better cycling performance.

In some embodiments of the first aspect of this application, 20 N/m≤F≤30 N/m.

In the foregoing technical solution, 20 N/m≤F≤30 N/m, so that the protective member and the separator have better connection stability, and the battery has better infiltration performance, and thus the battery has better cycling performance.

In some embodiments of the first aspect of this application, the separator includes an extending portion beyond an edge of the first electrode plate and an edge of the second electrode plate; where the protection member is fixed to the extending portion.

In the foregoing technical solution, the protective member is fixed to the extending portion of the separator beyond the edge of the second electrode plate and the edge of the first electrode plate, which helps to fix the protective member to the separator.

In some embodiments of the first aspect of this application, the extending portion includes a bending section located at an end of the separator in a length direction of the electrode assembly, where the protective member is fixed to a surface of the bending section facing the second portion.

In the foregoing technical solution, the protective member is fixed to the surface of the bending section facing the second portion, which not only facilitates the fixing of the protective member to the separator but also can provide a larger connection area between the protective member and the separator, and helps to enhance the connection stability between the protective member and the separator.

In some embodiments of the first aspect of this application, the separator includes a base material layer and a ceramic layer, where the ceramic layer is arranged on a surface of the base material layer, and the protective member is fixed to a portion of the base material layer located at the bending section.

In the foregoing technical solution, a surface of the base material is relatively rougher than a surface of the ceramic layer, and the protective member is fixed to the portion of the base material layer located at the bending section, which can enhance the connection stability between the protective member and the separator.

In some embodiments of the first aspect of this application, the protective member is a porous structure, and a porosity of the protective member ranges from 10% to 30%. When the porosity is too low, the protective member is relatively dense, the infiltration effect of the electrolyte is not ideal, and the porosity is generally maintained at 10% to 30%.

In the foregoing technical solution, the protective member is a porous structure and has a porosity of 10% to 30%, which is easier for the electrolyte to infiltrate the protective member, helps to improve the cycling performance of the battery, and also helps the protective member to have good insulation performance.

In some embodiments of the first aspect of this application, the protective member is provided with a through hole, where the through hole has a radius of R, and 0.25 mm≤R≤1 mm. If the radius of the through hole is too small, it is not conducive to the infiltration of the electrolyte; and if the radius of the through hole is too large, the first tab (especially the second portion of the first tab) is prone to pass through the through hole and be electrically connected to the second electrode plate, thereby causing a short circuit.

In the foregoing technical solution, the protective member is provided with a through hole, which is conducive to the infiltration of the electrolyte into the protective member. The radius R of the through hole meets 0.25 mm≤R≤1 mm, so that the electrolyte can quickly and fully infiltrate the protective member, thereby improving the cycling performance of the battery.

In some embodiments of the first aspect of this application, the protective member is provided with the through hole, where the through hole of the protective member has a density of P, and 2 holes/cm²≤P≤5 holes/cm².

In the foregoing technical solution, 2 holes/cm²≤P≤5 holes/cm², so that the electrolyte can fully infiltrate the protective member, improving the cycling performance of the battery and also giving the protective member good strength.

In some embodiments of the first aspect of this application, the protective member is an adhesive tape or an insulating inorganic coating bonded to the separator.

In the foregoing technical solution, the protective member is an adhesive tape bonded to the separator, which helps to fix the protective member to the separator. The protective member is an insulating inorganic coating bonded to the separator, so that the protective member and the separator have better connection stability.

In some embodiments of the first aspect of this application, the adhesive tape is made of at least one of silicone, epoxy resin, polyurethane, polyethylene terephthalate, or polyimide; and the insulating inorganic coating includes at least one of boehmite or alumina.

In the foregoing technical solution, the foregoing materials all have high melting points, which helps to enhance the connection stability between the protective member and the separator.

In some embodiments of the first aspect of this application, the protective member has a melting point of A, where A>160° C.

In the foregoing technical solution, the melting point A of the protective member is greater than 160° C., so that the protective member can insulate and separate the second portion of the first tab from the second electrode plate at high temperatures, further improving the safety performance of the battery.

In some embodiments of the first aspect of this application, the protective member has a thickness of H, where 20 μm≤H≤80 μm.

In a typical battery, a distance between the housing and the negative electrode plate ranges from 0.5 nm to 1.5 mm. If the protective member is too thick, a space of the tab is squeezed, which will worsen the drop performance and cause process issues such as bulging at the head of the battery. If a distance between a packaging film at the head of the battery and the negative electrode is increased, the energy density will be lost; but if the protective member is too thin, it is difficult to implement in the process or the protective member is easily pierced by burrs of the tab, causing a short circuit. In the foregoing technical solution, 20 μm≤H≤80 μm, so that the protective member has good strength and can also reduce the occupation of protective member in the space of the housing, which is conducive to the battery cell having high energy density.

In some embodiments of the first aspect of this application, the first electrode plate is a positive electrode plate, and the second electrode plate is a negative electrode plate.

In the foregoing technical solution, in the length direction of the electrode assembly, the negative electrode plate extends beyond the positive electrode plate, with the negative electrode plate being closer to the second portion relative to the positive electrode plate. The arrangement of the protective member between the second portion of the first tab and the electrode assembly effectively reduces the risk of short circuit caused by the second portion of the first tab connected to the positive electrode plate contacting the negative electrode plate, thereby improving the safety performance of the battery.

According to a second aspect, an embodiment of an embodiment of this application further provides an electric device including the battery according to any one of the foregoing embodiments.

In the foregoing technical solution, the battery provided in any of the foregoing embodiments has good safety, so that the electric device powered by this battery has better electrical safety and stability.

### BRIEF DESCRIPTION OF DRAWINGS

To describe the technical solutions of some embodiments of this application more clearly, the following briefly describes the accompanying drawings required for describing these embodiments. It is appreciated that the accompanying drawings below show merely some embodiments of this application and thus should not be considered as limitations on the scope. Persons of ordinary skill in the art may still derive other related drawings from the accompanying drawings without creative efforts.

FIG. 1 is a schematic structural diagram of a battery according to some embodiments of this application;

FIG. 2 is a cross-sectional view taken along line A1-A1 in FIG. 1;

FIG. 3 is a schematic structural diagram of a battery according to some other embodiments of this application;

FIG. 4 is a cross-sectional view taken along line A2-A2 in FIG. 3;

FIG. 5 is a partial schematic diagram of an electrode assembly and a first tab after connection according to some embodiments of this application;

FIG. 6 is a schematic diagram of a protective member arranged between the electrode assembly and a second portion in FIG. 5;

FIG. 7 is a partial schematic diagram of an electrode assembly and a first tab after connection according to some other embodiments of this application;

FIG. 8 is a schematic diagram of a protective member arranged between the electrode assembly and a second portion in FIG. 7;

FIG. 9 is a schematic structural diagram of a separator according to some embodiments of this application;

FIG. 10 is a schematic structural diagram of a protective member with a through hole according to some embodiments of this application; and

FIG. 11 is a schematic structural diagram of a protective member according to some embodiments of this application.

Reference signs: 100: battery; 10: housing; 20: electrode assembly; 21: first electrode plate; 22: second electrode plate; 23: separator; 231: extending portion; 2311: bending section; 232: base material layer; 233: ceramic layer; 30: first tab; 31: first portion; 32: second portion; 33: third portion; 40: protective member; 41: through hole; 50: tab glue; 60: second tab; 61: fourth portion; 62: fifth portion; 63: sixth portion; X: length direction of electrode assembly; Y: thickness direction of electrode assembly; and Z: width direction of electrode assembly.

### DETAILED DESCRIPTION

To make the objectives, technical solutions, and advantages of some embodiments of this application clearer, the following clearly and completely describes the technical solutions in some embodiments of this application with reference to the accompanying drawings in some embodiments of this application. Apparently, the described embodiments are some but not all embodiments of this application. Generally, the components in some embodiments of this application as described and illustrated in the accompanying drawings herein can be arranged and designed in a variety of configurations.

Therefore, the following detailed description of some embodiments of this application as provided in the accompanying drawings is not intended to limit the protection scope of this application but merely to represent selected embodiments of this application. All other embodiments obtained by persons of ordinary skill in the art based on some embodiments of this application without creative efforts shall fall within the protection scope of this application.

It should be noted that in absence of conflicts, some embodiments and features in some embodiments in this application may be combined with each other.

It should be noted that similar reference numerals and letters indicate similar items in the following drawings, and therefore once an item is defined in one drawing, it does not need to be further defined or explained in the subsequent drawings.

In the description of some embodiments of this application, it should be noted that the orientations or positional relationships as indicated are orientations or positional relationships based on the accompanying drawings, or conventional orientations or positional relationships of products of this application in use, or orientations or positional relationships as conventionally understood by persons skilled in the art, and the orientations or positional relationships as indicated are merely for ease and brevity of description of this application rather than indicating or implying that the apparatuses or elements mentioned must have specific orientations or must be constructed or manipulated according to specific orientations, and therefore shall not be construed as any limitations on this application. In addition, the terms “first”, “second”, “third”, and the like are merely intended for distinguishing purposes and shall not be understood as any indication or implication of relative importance.

Currently, from the perspective of market development, application of batteries is being more extensive. Battery cells have been widely used in many fields such as electric transportation tools including electric bicycles, electric motorcycles, and electric vehicles, electric tools, unmanned aerial vehicles, and energy storage devices. With the continuous expansion of application fields of secondary batteries, market demands for secondary batteries are also increasing.

A battery includes a housing, an electrode assembly, a positive electrode tab, and a negative electrode tab. The electrode assembly is accommodated in the housing, the positive electrode tab is electrically connected to a positive electrode plate of the electrode assembly, and the negative electrode tab is electrically connected to a negative electrode plate of the electrode assembly. To mitigate the excessive movement amplitude of the electrode assembly inside the housing during falling of the battery, the positive electrode tab and negative electrode tab are bending structures to act as buffers during falling of the battery, reducing the movement amplitude of the electrode assembly inside the housing.

After a short circuit of the battery or in the process of the battery hot box, the temperature at a tab rises, and a large amount of heat causes a tab glue to melt, exposing a portion of the tab. The tab glue is a glue that is in contact with the tab and plays the role of sealing and insulation at a position where the tab extends out of the housing. Meanwhile, after the short circuit or during thermal process, the battery is heated and a thermochemical reaction occurs, producing a large amount of oxidizing or reducing gas. Significant thermal accumulation occurs inside the battery. Swelling and deformation of the housing of the battery will pull the tab and squeeze the electrode assembly, causing the tab to press on the separator and melt the separator, which can easily cause the bent positive electrode tab to be in contact with the negative electrode plate or the bent negative electrode tab to be in contact with the positive electrode plate, resulting in a secondary short circuit in the battery, further generating Joule heat to worsen the thermal accumulation inside the battery, and causing safety problems such as thermal runaway, combustion, or even explosion.

Based on the foregoing considerations, to alleviate safety problems such as explosions or fires of the battery caused by secondary short circuit of the battery, an embodiment of this application provides a battery. The battery includes a housing, an electrode assembly, and a protective member. The electrode assembly is accommodated in the housing, and the electrode assembly includes a first electrode plate, a second electrode plate, and a separator, where the first electrode plate and the second electrode plate have opposite polarities, and the separator is arranged between the first electrode plate and the second electrode plate. A first tab includes a first portion, a second portion, and a third portion, where the second portion connects the first portion and the third portion, the first portion is connected to the first electrode plate, and the third portion extends out of the housing. The protective member is fixed to the separator or the second portion, and the protective member is located between the second portion and the electrode assembly to insulate and separate the second portion from the second electrode plate.

The protective member is arranged between the second portion of the first tab and the electrode assembly, which effectively reduces the risk of short circuit of the battery caused by contact between the second portion of the first tab and the second electrode plate, greatly reducing the risk of fire and explosion of the battery, thereby improving the safety performance of the battery.

In a case that a short circuit occurs in the battery, an internal gas pressure of the battery is relatively high, the battery swells severely, and the first tab is pulled and likely to be deformed. The protective member is arranged between the second portion of the first tab and the electrode assembly, so that the protective member can reduce the risk of the first tab being pulled and deformed due to swelling of the battery and being in contact with the second electrode plate, thereby reducing the risk of secondary short circuit of the battery, further reducing the risk of fire and explosion of the battery, and improving the safety performance of the battery.

The protective member is fixed to the separator or the second portion, which can enhance the installation stability of the protective member. Even after the internal environment of the battery 100 changes, the protective member can also maintain a stable relative position, thereby effectively insulating and separating the second portion of the first tab from the second electrode plate, which helps to improve the safety performance of the battery.

The battery disclosed in this embodiment of this application may be used in, but is not limited to, electric devices such as electric two-wheelers, electric tools, unmanned aerial vehicles, and energy storage devices. A battery with the working conditions of this application can also be used as the power system of electric devices, which helps to improve the safety performance of the battery.

An embodiment of this application provides an electric device that uses a battery as a power source. The electric device may be but is not limited to an electronic device, an electric tool, an electric transportation tool, an unmanned aerial vehicle, or an energy storage device. The electronic device may include a mobile phone, a tablet computer, a notebook computer, or the like, the electric tool may include an electric drill, an electric saw, or the like, and the electric transportation tool may include an electric vehicle, an electric motorcycle, an electric bicycle, or the like.

As shown in FIG. 1 to FIG. 4, an embodiment of this application provides a battery 100. The battery 100 includes a housing 10, an electrode assembly 20, a first tab 30, and a protective member 40. The electrode assembly 20 is accommodated in the housing 10, and the electrode assembly 20 includes a first electrode plate 21, a second electrode plate 22, and a separator 23. The first electrode plate 21 and the second electrode plate 22 have opposite polarities, and the separator 23 is arranged between the first electrode plate 21 and the second electrode plate 22. The first tab 30 includes a first portion 31, a second portion 32, and a third portion 33. The second portion 32 connects the first portion 31 and the third portion 33, the first portion 31 is connected to the first electrode plate 21, and the third portion 33 extends out of the housing 10. The protective member 40 is fixed to the separator 23 or the second portion 32, and the protective member 40 is located between the second portion 32 and the electrode assembly 20 to insulate and separate the second portion 32 from the second electrode plate 22.

The protective member 40 is arranged between the second portion 32 of the first tab 30 and the electrode assembly 20, which effectively reduces the risk of short circuit of the battery 100 caused by contact between the second portion 32 of the first tab 30 and the second electrode plate 22, greatly reducing the risk of fire and explosion of the battery 100, thereby improving the safety performance of the battery 100.

In a case that a short circuit occurs in the battery 100, an internal gas pressure of the battery 100 is relatively high, the battery 100 swells severely, the first tab 30 is pulled and likely to be deformed. The protective member 40 is ranged between the second portion 32 of the first tab 30 and the electrode assembly 20, so that the protective member 40 can reduce the risk of the first tab 30 being pulled and deformed due to swelling of the battery 100 and being in contact with the second electrode plate 22, thereby lowering the risk of secondary short circuit of the battery 100, further reducing the risk of fire and explosion of the battery 100, and improving the safety performance of the battery 100.

The protective member 40 is fixed to the separator 23 or the second portion 32, which can enhance the installation stability of the protective member 40. Even after the internal environment of the battery 100 changes, the protective member 40 can also maintain a stable relative position, thereby effectively insulating and separating the second portion 32 of the first tab 30 from the second electrode plate 22, which helps to improve the safety performance of the battery 100.

The housing 10 may be a rigid shell, for example, the housing 10 may be a steel shell or an aluminum shell, forming a steel shell battery 100 or an aluminum shell battery 100.

The housing 10 may alternatively be made of relatively soft materials, for example, the housing 10 may be an aluminum-plastic film or a steel-plastic film, forming a pouch battery cell. When the housing 10 is an aluminum-plastic film or steel-plastic film, the housing 10 is more prone to deformation. After the generation of gas due to high temperature inside the battery 100, the housing 10 may alleviate the internal swelling of the battery 100 through deformation of the housing 10 itself, reducing the risk of explosion of the battery 100.

The electrode assembly 20 may be a stacked electrode assembly 20, where at least one first electrode plate 21, at least one second electrode plate 22, and at least one separator 23 are stacked in a certain order. The separator 23 is arranged between the first electrode plate 21 and the second electrode plate 22 to insulate and separate the first electrode plate 21 from the second electrode plate 22, reducing the risk of short circuit in the battery 100.

The electrode assembly 20 may alternatively be a wound electrode assembly 20. The first electrode plate 21, the second electrode plate 22, and the separator 23 are stacked in a certain order and wound around a central winding axis to form a wound electrode assembly 20. The separator 23 is arranged between the first electrode plate 21 and the second electrode plate 22, and the separator 23 is configured to insulate and separate the first electrode plate 21 from the second electrode plate 22.

Along a length direction X of the electrode assembly, two ends of the separator 23 extend beyond two ends of the first electrode plate 21 and two ends of the second electrode plate 22. The separator 23 may be made of PP (polypropylene, polypropylene) or PE (polyethylene, polyethylene).

The first electrode plate 21 includes a first current collector and a first active material layer, where the first active material layer is arranged on at least one surface of the first current collector in a thickness direction of the first current collector. The second electrode plate 22 includes a second current collector and a second active material layer, where the second active material layer is arranged on at least one surface of the second current collector in a thickness direction of the second current collector.

The first tab 30 is connected to the first electrode plate 21. Specifically, the first tab 30 is connected to the first current collector. The first tab 30 and the first current collector may be integrally formed, for example, the first tab 30 and the first current collector are formed by die-cutting a substrate, thereby achieving the integral formation of the first tab 30 and the first current collector. The first tab 30 and the first current collector may be separately arranged and then connected as a whole through welding, conductive adhesive, riveting, or the like.

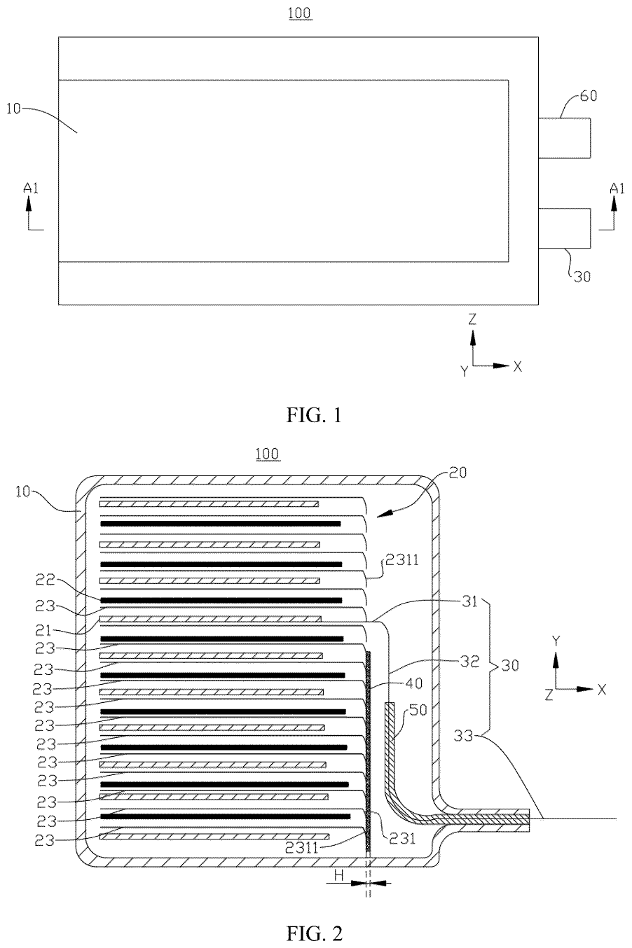

The first tab 30 protrudes from one end of the first electrode plate 21 along the length direction X of the electrode assembly. The first tab 30 extends along the length direction X of the electrode assembly, and then extends out of the housing 10 after bending. The bent first tab 30 helps to act as a buffer during falling of the battery 100, reducing the movement range of the electrode assembly 20 inside the housing 10. The bent first tab 30 forms the first portion 31, the second portion 32, and the third portion 33. The first portion 31 is connected to the first electrode plate 21, the third portion 33 extends out of the housing 10, and the first portion 31 and the second portion 32 are spaced apart in a thickness direction Y of the electrode assembly. When viewed in the thickness direction Y of the electrode assembly, the first portion 31 and the third portion 33 may partially overlap or may not overlap. FIG. 2 shows a situation where the first portion 31 and the third portion 33 do not overlap when viewed in the thickness direction Y of the electrode assembly. Two ends of the second portion 32 are respectively connected to an end of the first portion 31 away from the first electrode plate 21 and an end of the third portion 33 located inside the housing 10. Along the length direction X of the electrode assembly, the second portion 32 is located at an end of the electrode assembly 20. The third portion 33 and the housing 10 are sealed by tab glue 50. The thickness direction Y of the electrode assembly is perpendicular to the length direction X of the electrode assembly.

The battery 100 further includes a second tab 60, where the second tab 60 is connected to the second electrode plate 22. Specifically, the second tab 60 is connected to the second current collector. The second tab 60 and the second current collector may be integrally formed, for example, the second tab 60 and the second current collector are formed by die-cutting a substrate, thereby achieving the integral formation of the second tab 60 and the second current collector. The second tab 60 and the second current collector may be separately arranged and then connected as a whole through welding, conductive adhesive, riveting, or the like.

The second tab 60 protrudes from one end of the second electrode plate 22 along the length direction X of the electrode assembly. The second tab 60 extends along the length direction X of the electrode assembly, and then may extend out of the housing 10 after bending. The bent second tab 60 helps to act as a buffer during falling of the battery 100, reducing the movement range of the electrode assembly 20 inside the housing 10. The bent second tab 60 may form a fourth portion 61, a fifth portion 62, and a sixth portion 63. The fourth portion 61 is connected to the second electrode plate 22, the sixth portion 63 extends out of the housing 10, and the fourth portion 61 and the sixth portion 63 are spaced apart in the thickness direction Y of the electrode assembly. When viewed in the thickness direction Y of the electrode assembly, the fourth portion 61 and the sixth portion 63 may partially overlap or may not overlap. Two ends of the fifth portion 62 are respectively connected to an end of the fourth portion 61 away from the second electrode plate 22 and an end of the sixth portion 63 located inside the housing 10. Along the length direction X of the electrode assembly, the fifth portion 62 is located at an end of the electrode assembly 20. The sixth portion 63 and the housing 10 are sealed by tab glue 50.

As shown in FIG. 1 and FIG. 2, the second tab 60 and the first tab 30 may protrude from a same end of the electrode assembly 20 along the length direction X of the electrode assembly. In this case, one portion of the protective member 40 may be fixed to the separator 23 or the second portion 32, and is located between the second portion 32 and the electrode assembly 20 to insulate and separate the second portion 32 from the second electrode plate 22. Another portion of the protective member 40 may be fixed to the separator 23 or the fifth portion 62 of the second tab 60, and is located between the fifth portion 62 of the second tab 60 and the electrode assembly 20 to insulate and separate the fifth portion 62 from the first electrode plate 21, thereby reducing the risk of short circuit in the battery 100 caused by contact between the first tab 30 and the second electrode plate 22 and contact between the second tab 60 and the first electrode plate 21, and also reducing the risk of secondary short circuit in the battery 100, and improving the safety performance of the battery 100.

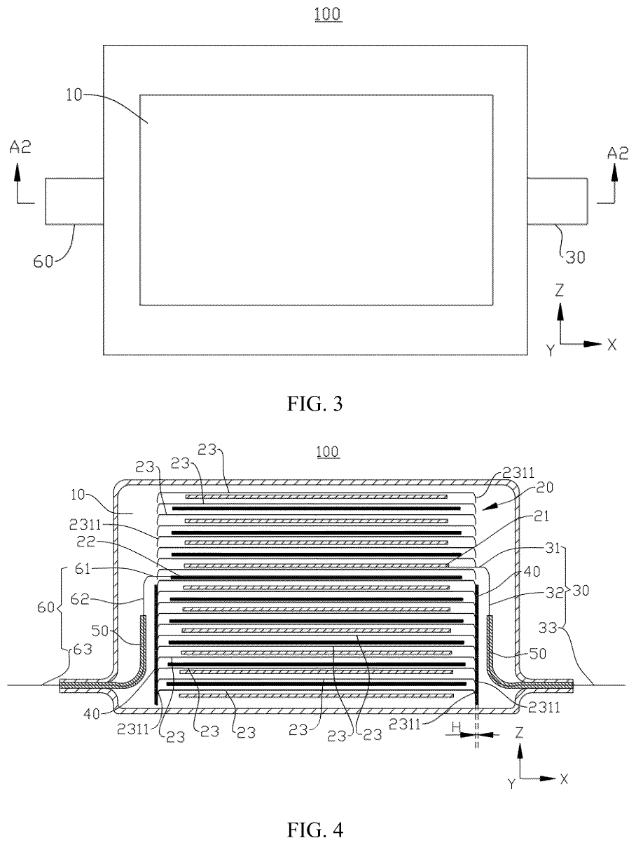

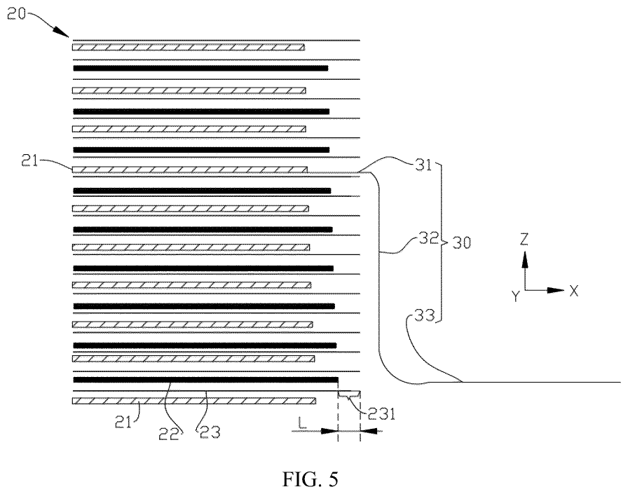

In some other embodiments, as shown in FIG. 3 and FIG. 4, the first tab 30 and the second tab 60 may alternatively protrude from two opposite ends of the electrode assembly 20 along the length direction X of the electrode assembly respectively. In this case, the battery 100 may include two protective members 40. One protective member 40 of the two protective members 40 is fixed to the separator 23 or the second portion 32, and is located between the second portion 32 and the electrode assembly 20 to insulate and separate the second portion 32 from the second electrode plate 22. The other protective member 40 of the two protective members 40 is fixed to the separator 23 or the fifth portion 62 of the second tab 60, and is located between the fifth portion 62 of the second tab 60 and the electrode assembly 20 to insulate and separate the fifth portion 62 from the second electrode plate 22, thereby reducing the risk of short circuit in the battery 100 caused by contact between the first tab 30 and the second electrode plate 22 and contact between the second tab 60 and the first electrode plate 21, also reducing the risk of secondary short circuit in the battery 100, and improving the safety performance of the battery 100. The sixth portion 63 and the housing 10 are sealed by tab glue 50.

The first electrode plate 21 and the second electrode plate 22 have opposite polarities, to be specific, the first electrode plate 21 is a positive electrode plate, and the second electrode plate 22 is a negative electrode plate.

In some embodiments, the first electrode plate 21 is a positive electrode plate, and the second electrode plate 22 is a negative electrode plate.

Therefore, the first current collector is a positive electrode current collector, and the first active material layer is a positive electrode active material layer. A lithium-ion battery 100 is used as an example. The positive electrode current collector may be made of aluminum, and the positive electrode active material may be lithium cobalt oxide, lithium iron phosphate, lithium ternary, lithium manganese oxide, or the like. The second current collector is a negative electrode current collector, and the second active material layer is a negative electrode active material layer. The negative electrode current collector may include copper, and the negative electrode active material may be carbon, silicon, or the like.

The first electrode plate 21 is a positive electrode plate, the first tab 30 is connected to the first electrode plate 21, and the first tab 30 is a positive electrode tab. The material of the first tab 30 may be the same as or different from the material of the first current collector of the first electrode plate 21.

The second electrode plate 22 is a negative electrode plate, the second tab 60 is connected to the second electrode plate 22, and the second tab 60 is a negative electrode tab. The material of the second tab 60 may be the same as or different from the material of the second current collector of the second electrode plate 22.

Along the length direction X of the electrode assembly, the negative electrode plate extends beyond the positive electrode plate, the separator 23 extends beyond the negative electrode plate, the separator 23 is closest to the second portion 32 relative to the positive electrode plate and the negative electrode plate, and the negative electrode plate is closer to the second portion 32 relative to the positive electrode plate. As shown in FIG. 5, a length of an end of the separator 23 close to the second portion 32 that extends beyond an end of the negative electrode plate close to the second portion 32 is L, where 1 mm≤L≤3 mm, so that the negative electrode plate can cover the positive electrode plate, the negative electrode plate has enough position for ions deintercalated from the positive electrode plate to be intercalated, reducing the risk of lithium precipitation in the battery 100. For example, L may be 1 mm, 1.5 mm, 2 mm, 2.5 mm, 3 mm, or the like. Because the negative electrode plate is closer to the second portion 32 relative to the positive electrode plate after the first tab 30 is bent, the negative electrode plate is prone to be in contact with the second portion 32. The arrangement of the protective member 40 can insulate and separate the second portion 32 from the negative electrode plate, effectively reducing the risk of short circuit in the battery 100 caused by contact between the positive electrode tab and the negative electrode plate, greatly reducing the risk of fire and explosion in the battery 100, and improving the safety performance of the battery 100. In addition, in a case that a short circuit occurs in the battery 100, an internal gas pressure of the battery 100 is relatively high, the battery 100 swells severely, the positive electrode tab is pulled and likely to be deformed. The protective member 40 is ranged between the second portion 32 of the positive electrode tab and the electrode assembly 20, so that the protective member 40 can reduce the risk of the positive electrode tab being pulled and deformed due to swelling of the battery 100 and being in contact with the negative electrode plate, thereby lowering the risk of secondary short circuit of the battery 100, further reducing the risk of fire and explosion of the battery 100, and improving the safety performance of the battery 100.

The protective member 40 is located at an end of the electrode assembly 20 along the length direction X of the electrode assembly. Along the length direction X of the electrode assembly, the protective member 40 is located between the electrode assembly 20 and the second portion 32. When viewed along the length direction X of the electrode assembly, a projection of the second portion 32 falls within a projection of the protective member 40.

The protective member 40 is made of an insulating material, so that the protective member 40 can insulate and separate the second portion 32 from the second electrode plate 22, reducing the risk of short circuit in the battery 100 caused by the contact between the second portion 32 and the second electrode plate 22.

The protective member 40 may be fixed to a surface of the second portion 32 facing the electrode assembly 20. For example, the protective member 40 may be bonded to the surface of the second portion 32 facing the electrode assembly 20, the protective member 40 may be applied on the surface of the second portion 32 facing the electrode assembly 20, and the like, to achieve the fixing of the protective member 40 on the surface of the second portion 32 facing the electrode assembly 20. In an embodiment where the protective member 40 is bonded to the surface of the second portion 32 facing the electrode assembly 20, a surface of the protective member 40 away from the second portion 32 may have no adhesive ability. In some other embodiments, the surface of the protective member 40 away from the second portion 32 may alternatively have adhesive ability.

The protective member 40 may be fixed to the separator 23. For example, the protective member 40 may be bonded to the separator 23, the protective member 40 may be applied on the separator 23, or the like, to achieve the fixing of the protective member 40 on the separator 23. In an embodiment where the protective member 40 is bonded to the separator 23, the surface of the protective member 40 away from the separator 23 may have no adhesive ability. In some other embodiments, the surface of the protective member 40 away from the separator 23 may alternatively have adhesive ability. The surface of the protective member 40 away from the separator 23 is also a surface of the protective member 40 facing the second portion 32.

In an embodiment where the protective member 40 is bonded to the separator 23, the adhesive force between the protective member 40 and the separator 23 is F, where 6 N/m≤F≤50 N/m. The protective member 40 is bonded to the separator 23, the connection method is simple, and the connection stability is good. 6 N/m≤F≤50 N/m, so that the protective member 40 and the separator 23 have good connection stability, and the battery 100 has good infiltration performance, and thus the battery 100 has better cycling performance.

The adhesive force F between the protective member 40 and the separator 23 may be measured by the following method: using a high-speed traction machine, prepare a protective member 40 attached with a rectangular separator 23 sample with a width of 20 mm and a length of 60 mm to 70 mm, and conducting a 90° peel test to measure the adhesive force between the separator 23 and the protective member 40.

For example, the adhesive force F between the separator 23 and the protection member 40 may be 6 N/m, 10 N/m, 15 N/m, 20 N/m, 25 N/m, 30 N/m, 35 N/m, 40 N/m, 45 N/m, 50 N/m, or the like.

In some embodiments, 20 N/m≤F≤30 N/m, so that the protective member 40 and the separator 23 have better connection stability, the battery 100 has better infiltration performance, and thus the battery 100 has better cycling performance.

For example, F may be 20 N/m, 21 N/m, 22 N/m, 23 N/m, 24 N/m, 26 N/m, 27 N/m, 28 N/m, 29 N/m, 30 N/m, or the like.

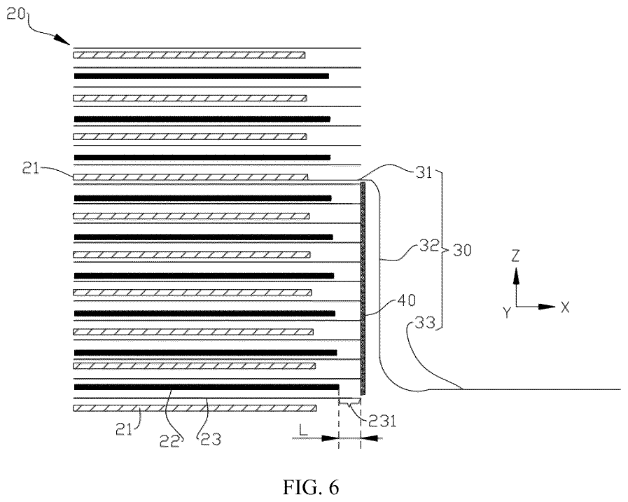

As shown in FIG. 5 and FIG. 6, in an embodiment where the protective member 40 is fixed to the separator 23, the protective member 40 may be fixed to an end face of the separator 23 along the length direction X of the electrode assembly, or the protective member 40 may be fixed to a surface of the separator 23 along the thickness direction Y of the electrode assembly.

In an embodiment where the protective member 40 is fixed to a surface of the separator 23 along the thickness direction Y of the electrode assembly, a connection position between the protective member 40 and the separator 23 may be located between the first electrode plate 21 and the second electrode plate 22, or a connection position between the protective member 40 and the separator 23 may be located at a position where the separator 23 extends beyond an edge of the first electrode plate 21 and an edge of the second electrode plate 22.

As shown in FIG. 5 to FIG. 8, in some embodiments, the separator 23 includes an extending portion 231 that extends beyond an edge of the first electrode plate 21 and an edge of the second electrode plate 22, where the protective member 40 is fixed to the extending portion 231. The protective member 40 is fixed to the extending portion 231 of the separator 23 beyond the edge of the second electrode plate 22 and the edge of the first electrode plate 21, so that the protective member 40 is conveniently fixed to the separator 23.

The extending portion 231 to which the protective member 40 is fixed is a portion of the separator 23 that extends beyond an edge of the first electrode plate 21 closest to the second portion 32 and an edge of the second electrode plate 22 closest to the second portion 32. The protective member 40 may be fixed to an end face of the extending portion 231 along the length direction X of the electrode assembly, so that the protective member 40 is fixed to the end face of the separator 23 along the length direction X of the electrode assembly.

The protective member 40 may be fixed to a surface of the extending portion 231 along the thickness direction Y of the electrode assembly, so that the protective member 40 is fixed to the surface of the separator 23 along the thickness direction Y of the electrode assembly. In this case, when viewed along the thickness direction Y of the electrode assembly, a connection position between the protective member 40 and the separator 23 does not overlap with the first electrode plate 21, and a connection position between the protective member 40 and the separator 23 does not overlap with the second electrode plate 22.

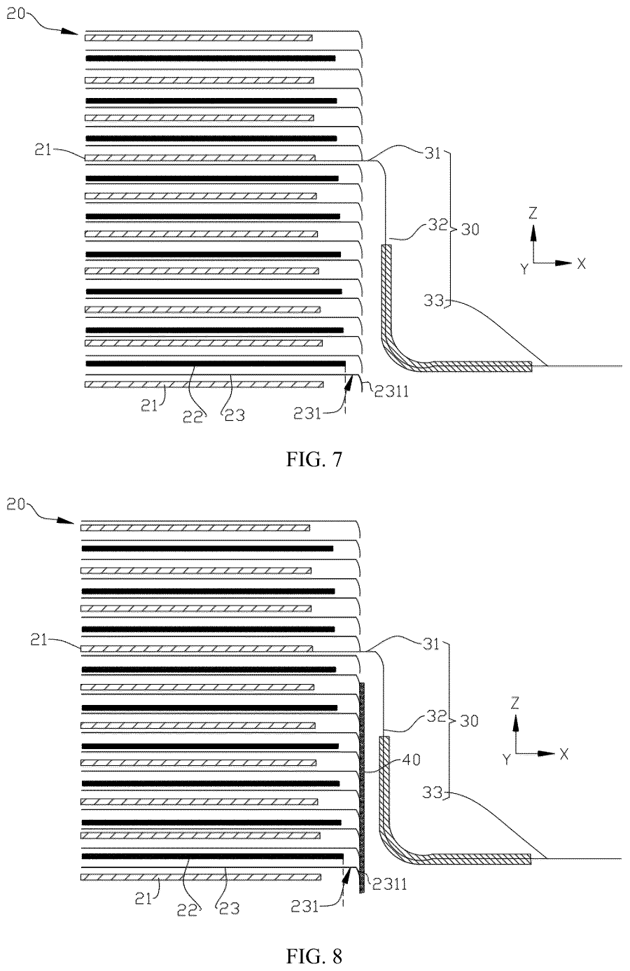

In some embodiments, the extending portion 231 may extend linearly along a length direction C of the electrode assembly. As shown in FIG. 7 and FIG. 8, in some other embodiments, the extending portion 231 includes a bending section 2311 located at an end portion of the separator 23 in the length direction X of the electrode assembly, where the protective member 40 is fixed to a surface of the bending section 2311 facing the second portion 32.

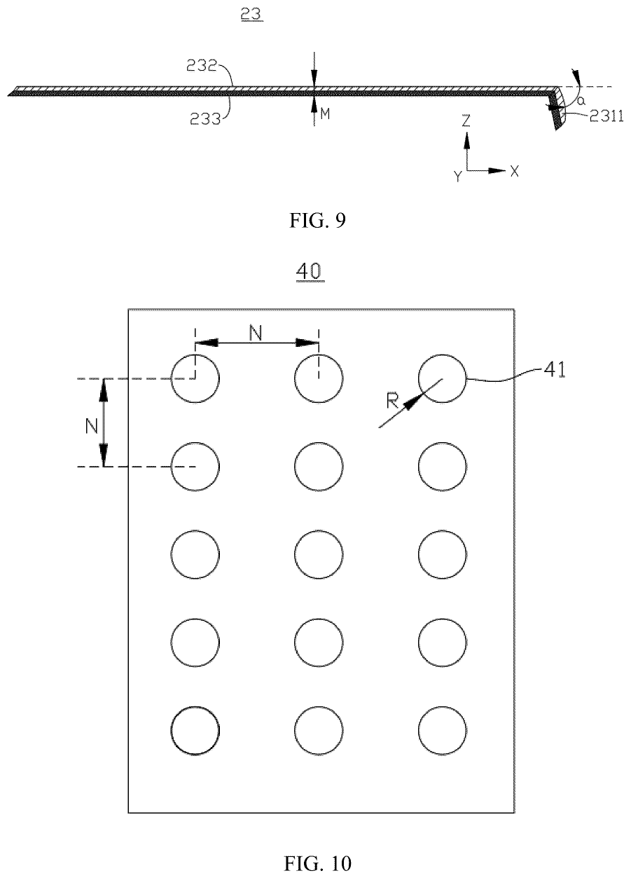

The extending portion 231 forms a bending portion after being bent around an axis parallel to a width direction Z of the electrode assembly. A bending angle of the extending portion 231 around the axis parallel to the width direction Z of the electrode assembly may be selected according to actual needs. For example, as shown in FIG. 9, the bending angle α of the extending portion 231 around the axis parallel to the width direction Z of the electrode assembly is less than or equal to 90°, along the length direction X of the electrode assembly, the bending portion may be located between the first electrode plate 21 and the second portion 32, and the bending portion may be located between the second electrode plate 22 and the second portion 32. The bending portion has a surface facing the second portion 32, and the protective member 40 is fixed to the surface of the bending section 2311 facing the second portion 32. For example, the protective member 40 is bonded to the surface of the bending section 2311 facing the second portion 32.

The protective member 40 is fixed to the surface of the bending section 2311 facing the second portion 32, which not only facilitates the fixing of the protective member 40 to the separator 23, but also provides a larger connection area between the protective member 40 and the separator 23, and helps to enhance the connection stability between the protective member 40 and the separator 23.

As shown in FIG. 9, in some embodiments, the separator 23 includes a base material layer 232 and a ceramic layer 233, where the ceramic layer 233 is arranged on a surface of the base material layer 232, and the protective member 40 is fixed to a portion of the base material layer 232 located at the bending section 2311.

At the bending portion, a surface of the portion of the base material located at the bending portion and facing away from a portion of the ceramic layer 233 located at the bending portion is a surface of the bending portion facing the second portion 32.

The surface of the base material is relatively rougher than the surface of the ceramic layer 233, and the protective member 40 is fixed to the portion of the base material layer 232 located at the bending section 2311, which can enhance the connection stability between the protective member 40 and the separator 23. For example, the protective member 40 is bonded to the base material layer 232. Because the surface of the base material layer 232 is relatively rougher than the surface of the ceramic layer 233, a bonding area between an adhesive and the surface of the base material layer 232 is larger, so that an adhesive force between the protective member 40 and the base material is stronger, thereby enhancing the connection stability between the separator 23 and the protective member 40.

As shown in FIG. 9, in some embodiments, the separator 23 has a thickness of M, where M≤10 μm. In an embodiment where the separator 23 includes the base material layer 232 and the ceramic layer 233, M is a sum of a thickness of the base material layer 232 and a thickness of the ceramic layer 233.

In some embodiments, the protective member 40 may be an adhesive tape or insulating inorganic coating bonded to the separator 23. The protective member 40 is an adhesive tape bonded to the separator 23, so that the protective member 40 is conveniently fixed to the separator 23. The protective member 40 is an insulating inorganic coating bonded to the separator 23, so that the protective member 40 and the separator 23 have better connection stability.

In an embodiment where the protective member 40 is an adhesive tape, a material of the adhesive tape includes at least one of silicone, epoxy resin, polyurethane, polyethylene terephthalate, or polyimide. The adhesive tape may be made of any one of silicone, epoxy resin, polyurethane, polyethylene terephthalate, and polyimide. The adhesive tape may also be made of at least two of silicone, epoxy resin, polyurethane, polyethylene terephthalate, or polyimide.

Silicone, epoxy resin, polyurethane, polyethylene terephthalate, and polyimide all have high melting points, and can resist high internal temperatures or environmental temperatures of the battery 100, which helps to enhance the connection stability between the protective member 40 and the separator 23.

In an embodiment where the protective member 40 is an insulating inorganic coating bonded to the separator 23, the insulating inorganic coating includes at least one of boehmite or alumina. The coating may be made of any one of boehmite and alumina. The coating may alternatively be made of both boehmite and alumina. Boehmite and alumina have high melting points and can resist high internal temperatures or environmental temperatures of the battery 100, which helps to enhance the connection stability between the protective member 40 and the separator 23.

To enable the protective member 40 to adapt to high-temperature environments, in some embodiments, the protective member 40 has a melting point of A, where A>160° C.

For example, when the protective member 40 is made of ceramic, the melting point A of the protective member 40 is >1000° C. When the protective member 40 is made of PET (polyethylene terephthalate, polyethylene terephthalate), the melting point of the protective member 40 is 250° C. to 255° C. When the protective member 40 is made of PI (polyimide, Polyimide), the melting point A of the protective member 40 is ≥350° C.

The melting point A of the protective member 40 is >160° C., so that the protective member 40 can insulate and separate the second portion 32 of the first tab 30 from the second electrode plate 22 at high temperatures, further improving the safety performance of the battery 100.

In some embodiments, the protective member 40 is a porous structure, and a porosity of the protective member 40 ranges from 10% to 30%.

The porosity of the protective member 40 may be imaged and monitored using an industrial camera CCD or a high magnification microscope.

For example, the porosity of the protective member 40 may be 10%, 12%, 15%, 17%, 20%, 22%, 25%, 27%, 30%, or the like.

The protective member 40 is a porous structure, and the protective member 40 has a porosity of 10% to 30%, so that the electrolyte is more likely to infiltrate the protective member 40, which helps to improve the cycling performance of the battery 100 and also helps the protective member 40 have good insulation performance.

As shown in FIG. 10, in some embodiments, the protective member 40 is provided with a through hole 41, where the through hole 41 has a radius of R, and 0.25 mm≤R≤1 mm.

The through hole 41 may extend to two sides of the protective member 40 in a thickness direction of the protective member 40, which facilitates the infiltration of the electrolyte into the protective member 40 and the rapid passage of the electrolyte through the protective member 40, and helps to improve the cycling performance of the battery cell.

For example, the radius R of the through hole 41 may be 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 0.1 mm, or the like.

The protective member 40 is provided with a through hole 41, which facilitates the infiltration of the electrolyte into the protective member 40. The radius R of the through hole 41 meets 0.25 mm≤R≤1 mm, so that the electrolyte can quickly and fully infiltrate the protective member 40, thereby improving the cycling performance of the battery 100.

The protective member 40 has a plurality of through holes 41, and the plurality of through holes 41 are spaced apart from each other. The plurality of through holes 41 may be arranged in many ways, for example, arranged in matrix, or arranged in annular array, and FIG. 10 shows a case where the plurality of through holes 41 are arranged in a matrix.

A distance between the centers of any two adjacent through holes 41 is N, where N>4 mm, facilitating the arrangement of the through holes 41. For example, N may be 4 mm, 4.5 mm, 5 mm, 5.5 mm, 6 mm, or the like.

In an embodiment where the protective member 40 is provided with a through hole 41, the through hole 41 in the protective member 40 has a density P, where 2 holes/cm²≤P≤5 holes/cm².

P is a quantity of through holes 41 per square centimeter in the protective member 40. P may be 2 holes/cm², 3 holes/cm², 4 holes/cm², 5 holes/cm², or the like.

2 holes/cm²≤P≤5 holes/cm², so that the electrolyte can fully infiltrate the protective member 40, improving the cycling performance of the battery 100, and also allowing the protective member 40 to have better strength.

In an embodiment where the protective member 40 is a porous structure or the protective member 40 is provided with a through hole 41, if the protective member 40 is an adhesive tape bonded to the separator 23, the hole in the protective member 40 may be formed by pre-processing the adhesive tape, in other words, punching the protective member 40 before the adhesive tape is bonded to the separator 23. If the protective member 40 is a coating bonded to the separator 23, the hole in the protective member 40 may be formed by post-processing the protective member 40, in other words, punching the protective member 40 after the coating solidifies.

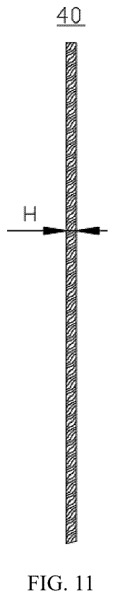

As shown in FIG. 2, FIG. 4, and FIG. 11, in some embodiments, the protective member 40 has a thickness of H, where 20 μm≤H≤80 μm.

As the protective member 40 is located between the electrode assembly 20 and the second portion 32 in the length direction X of the electrode assembly, the thickness H of the protective member 40 is a size of the protective member 40 along the length direction X of the electrode assembly. For example, H may be 20 μm, 30 μm, 40 μm, 50 μm, 60 μm, 70 μm, 80 μm, or the like.

20 μm≤H≤80 μm, so that the protective member 40 has better strength, and a space occupied by the protective member 40 in the housing 10 can be reduced, which is conducive to the battery cell having a higher energy density.

An embodiment of this application further provides an electric device, where the electric device includes the battery 100 according to any of the foregoing embodiments.

The battery 100 according to any of the foregoing embodiments has good safety, so that the electric device powered by this battery 100 has better electrical safety and stability.

The foregoing descriptions are merely preferred embodiments of this application which are not intended to limit this application. Persons skilled in the art understand that this application may have various modifications and variations. Any modification, equivalent replacement, and improvement made without departing from the spirit and principle of this application shall fall within the protection scope of this application.

1. A battery, comprising:
a housing;
an electrode assembly accommodated in the housing;
a first tab; and
a protective member;
wherein the electrode assembly comprises a first electrode plate, a second electrode plate, and a separator; the first electrode plate and the second electrode plate have opposite polarities, and the separator is arranged between the first electrode plate and the second electrode plate;
the first tab comprises a first portion, a second portion, and a third portion; the second portion connects the first portion and the third portion, the first portion is connected to the first electrode plate, and the third portion extends out of the housing;
wherein the protective member is fixed to the separator or the second portion, and the protective member is located between the second portion and the electrode assembly to insulate and isolate the second portion from the second electrode plate.

2. The battery according to claim 1, wherein an adhesive force between the protective member and the separator is F, wherein 6 N/m≤F≤50 N/m.

3. The battery according to claim 2, wherein 20 N/m≤F≤30 N/m.

4. The battery according to claim 1, wherein the separator comprises an extending portion extending beyond an edge of the first electrode plate and an edge of the second electrode plate;
wherein the protective member is fixed to the extending portion.

5. The battery according to claim 2, wherein the separator comprises an extending portion extending beyond an edge of the first electrode plate and an edge of the second electrode plate;
wherein the protective member is fixed to the extending portion.

6. The battery according to claim 3, wherein the separator comprises an extending portion extending beyond an edge of the first electrode plate and an edge of the second electrode plate;
wherein the protective member is fixed to the extending portion.

7. The battery according to claim 4, wherein the extending portion comprises a bending section located at an end of the separator in a length direction of the electrode assembly, wherein the protective member is fixed to a surface of the bending section facing the second portion.

8. The battery according to claim 7, wherein the separator comprises a base material layer and a ceramic layer, wherein the ceramic layer is arranged on a surface of the base material layer, and the protective member is fixed to a portion of the base material layer located at the bending section.

9. The battery according to claim 1, wherein the protective member has a porous structure, and a porosity of the protective member ranges from 10% to 30%.

10. The battery according to claim 1, wherein the protective member is provided with a through hole, wherein the through hole has a radius of R, and 0.25 mm≤R≤1 mm.

11. The battery according to claim 1, wherein the protective member is provided with a plurality of through holes, wherein a density of the plurality of through holes on the protective member is P, and 2 holes/cm²≤P≤5 holes/cm²; wherein each through hole has a radius of R, and 0.25 mm≤R≤1 mm.

12. The battery according to claim 1, wherein the protective member is an adhesive tape or an insulating inorganic coating bonded to the separator.

13. The battery according to claim 12, wherein the adhesive tape is made of at least one of silicone, epoxy resin, polyurethane, polyethylene terephthalate, or polyimide; and the insulating inorganic coating comprises at least one of boehmite or alumina.

14. The battery according to claim 1, wherein the protective member has a melting point of A, wherein A>160° C.

15. The battery according to claim 1, wherein the protective member has a thickness of H, wherein 20 μm≤H≤80 μm.

16. The battery according to claim 1, wherein the first electrode plate is a positive electrode plate, and the second electrode plate is a negative electrode plate.

17. The battery according to claim 16, wherein an end of the separator towards the second portion extends beyond an end of the negative electrode plate towards the second portion by a length L, and 1 mm≤L≤3 mm.

18. The battery according to claim 1, wherein the separator has a thickness of M, and M≤10 μm.

19. The battery according to claim 1, wherein the protective member has a porous structure, and a porosity of the protective member ranges from 10% to 30%.

20. An electric device, comprising the battery according to claim 1.
